(19) United States
(12) Patent Application Publication
(10) Pub. No.: US 2020/0387859 A1
(43) Pub. Date: Dec. 10, 2020

(54) Methods, Application Server, Block Chain Node and Media For Logistics Tracking and Source Tracing

(71) Applicant: VeChain Global Technology, S.AR.L, Luxembourg (LU)

(72) Inventors: Yanyu CHEN, Shanghai (CN); Jianliang GU, Shanghai (CN); Ziheng ZHOU, Shanghai (CN)

(21) Appl. No.: 15/733,523

(22) PCT Filed: Feb. 22, 2019
(86) PCT No.: PCT/CN2019/075773

§ 371 Date: Aug. 19, 2020

(30) Foreign Application Priority Data
Feb. 24, 2018 (CN) 201810157282.4

(51) Int. Cl. G06Q 10/08; H04L 9/06; H04L 9/32; H04L 9/08; G16Y 10/40

(52) U.S. Cl. CPC G06Q 10/0833; H04L 9/0637; H04L 2209/38; H04L 9/0825; G16Y 10/40; H04L 9/3297

(57) ABSTRACT

Embodiments of the present disclosure provide methods, an application server, a block chain node and storage medium for logistics tracking and source tracing of an object. The application server includes a memory and a processor, the memory being stored with machine executable instructions that, when executed by the processor, cause the application server to perform operations including: receiving a storage request from at least one node during a logistics process of the object; performing a hash operation on the information to obtain a hash value of the information; sending the hash value of the information and the information to a distributed database for storage; and sending the unique identification number of the object and the hash value of the information to a block chain platform for storage. With the embodiments of the present disclosure, it may be ensured that the object to be transported will not be replaced during the transportation process and that the information of the object will not be leaked or tampered with.

### FIELD

The present disclosure generally relates to the field of Internet of Things (IoT), and particularly to methods, an application server, a block chain node and computer readable storage media for logistics tracking and source tracing of an object.

### BACKGROUND

Currently, with the development of logistics transportation networks, more and more items are transported between different locations apart away from a distance of thousands of kilometers or even tens of thousands of kilometers through the logistics transportation network. Typically, when an item starts to be transported, the logistics company assigns a number in the form of a barcode or a two-dimensional code to the item as an identification of the item during the course of the logistics transportation. At each intermediate transfer node of the logistics company, logistic information such as the entry status and the delivery status of the item is recorded so that a user at the destination of the item may obtain the logistic information or trace the source of the item by querying the transportation records of the item.

However, in the above solution, numbers such as bar codes or two-dimensional codes are easily copied and attached to other items. All logistics information is stored on the centralized server of the logistics company, and thus it is easily to be tampered with or leaked.

### SUMMARY

Embodiments of the present disclosure provide methods, an application server, a block chain node and computer readable storage media for logistics tracking and source tracing of an object.

According to a first aspect of the present disclosure, an application server for logistics tracking and source tracing of an object is provided. The application server includes a memory and a processor, the memory being stored with machine executable instructions that, when executed by the processor, cause the application server to perform operations including: receiving a storage request from at least one node during a logistics process of the object, the storage request including a unique identification number of the object and information of the object at the at least one node, wherein the unique identification number of the object is a public key of an IoT device that is inseparable from the object during the logistics process; performing a hash operation on the information to obtain a hash value of the information; sending the hash value of the information and the information to a distributed database for storage; and sending the unique identification number of the object and the hash value of the information to a block chain platform for storage.

According to a second aspect of the present disclosure, a method for logistics tracking and source tracing of an object is provided. The method includes receiving a storage request from at least one node during a logistics process of the object, the storage request including a unique identification number of the object and information of the object at the at least one node, wherein the unique identification number of the object is a public key of an IoT device that is inseparable from the object during the logistics process; performing a hash operation on the information to obtain a hash value of the information; sending the hash value of the information and the information to a distributed database for storage; and sending the unique identification number of the object and the hash value of the information to a block chain platform for storage.

According to a third aspect of the present disclosure, a nonvolatile computer readable storage medium for logistics tracking and source tracing of an object is provided. The nonvolatile computer readable storage medium includes machine executable instructions that, when executed by a machine, are adapted to cause a machine to implement the method as described in the above second aspect.

According to a fourth aspect of the present disclosure, a block chain node for logistics tracking and source tracing of an object is provided. The block chain node includes a memory and a processor, the memory being stored with machine executable instructions that, when executed by the processor, cause the block chain node to perform operations including: receiving a storage request from an application server, the storage request including a unique identification number of the object and a hash value of information of the object at at least one node during a logistics process of the object, wherein the unique identification number of the object is a public key of an IoT device that is inseparable from the object during the logistics process; and distributing the unique identification number of the object and the hash value of the information to one or more other block chain nodes by using a smart contract.

According to a fifth aspect of the present disclosure, a method for logistics tracking and source tracing of an object is provided. The method includes receiving a storage request from an application server, the storage request including a unique identification number of the object and a hash value of information of the object at at least one node during a logistics process of the object, wherein the unique identification number of the object is a public key of an IoT device that is inseparable from the object during the logistics process; and distributing the unique identification number of the object and the hash value of the information to one or more other block chain nodes by using a smart contract.

According to a sixth aspect of the present disclosure, a nonvolatile computer readable storage medium for logistics tracking and source tracing of an object is provided. The nonvolatile computer readable storage medium includes machine executable instructions that, when executed by a machine, are adapted to cause a machine to implement the method as described in the above fifth aspect.

### BRIEF DESCRIPTION OF THE DRAWINGS

The present disclosure will be understood better and other objectives, details, features and advantages of the present disclosure will become more evident from the description of specific embodiments of the disclosure given in conjunction with the following figures, wherein:

FIG. 1 illustrates a structure block diagram of a system for logistics tracking and source tracing of an object according to embodiments of the present disclosure;

FIG. 2 illustrates a flow chart of a method for logistics tracking and source tracing of an object implemented in an application server according to embodiments of the present disclosure;

FIG. 3 illustrates a flow chart of a method for logistics tracking and source tracing of an object implemented in a block chain node according to embodiments of the present disclosure;

FIG. 4A illustrates a schematic diagram of the storage format in the block chain platform for the information of the object according to embodiments of the present disclosure;

FIG. 4B illustrates a schematic diagram of the storage format in the distributed database for the information of the object according to embodiments of the present disclosure; and

FIG. 5 illustrates a structure block diagram of an IoT device for logistics tracking and source tracing of an object according to embodiments of the present disclosure.

### DETAILED DESCRIPTION OF THE PREFERRED EMBODIMENTS

Embodiments of the present disclosure will now be described in more detail in conjunction with accompanying figures. Although embodiments of the present disclosure are shown in the accompanying figures, it should be understood that the present disclosure can be embodied in various ways but not be limited to the embodiments depicted herein. Instead, the embodiments are provided herein to make the disclosure more thorough and complete and convey the scope of the present disclosure to those skilled in the art.

As described above, in applications where bar codes or two-dimensional codes are used to track the logistics information or source of items, the numbers such as the bar codes or the two-dimensional codes are easily to be copied and attached to other items, so that it cannot be ensured that the receiver has received the desired item. Moreover, all information during the logistics process is stored on the centralized server of the logistics company, and thus it is easily to be tampered with or leaked.

In view of this, the embodiments of the present disclosure propose a solution that a public key of an IoT device that is inseparable from an object to be transported during the logistics process is used as a unique identification number of the object, and the information of the object is stored on the block chain with the unique identification number so that it can be ensured not only that the object received by the receiver of the object has not been replaced, but also that the object's information will not be leaked or tampered with.

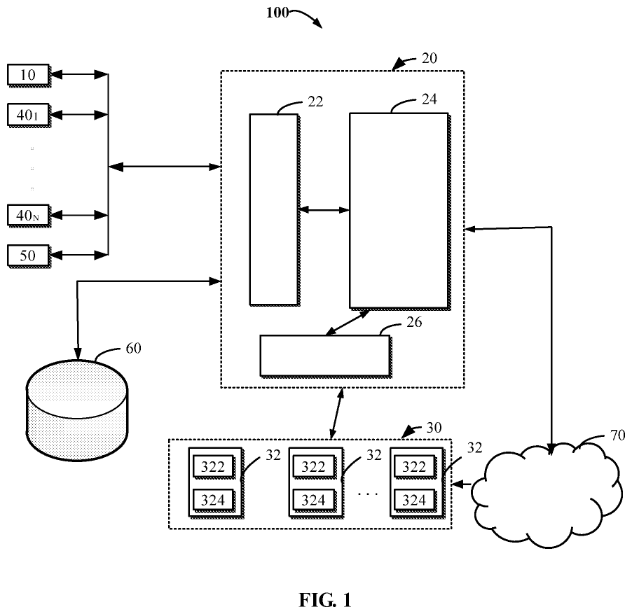

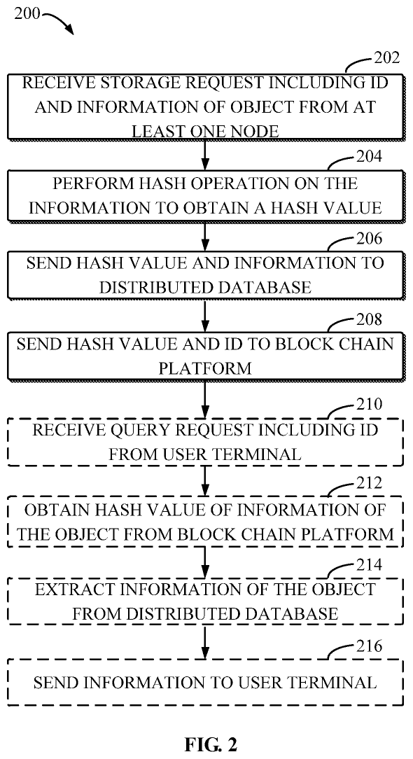

FIG. 1 illustrates a structure block diagram of a system 100 for logistics tracking and tracing of an object according to the present disclosure. As shown in FIG. 1, the system 100 includes an application server 20 that includes a transceiver 22, a processor 24, and a memory 26. In one implementation, the memory 26 has computer program codes stored thereon that, when executed by the processor 24, perform the method 200 described below in conjunction with FIG. 2. The processor 24 is configured to interact with at least one node during the logistics process of the object through the transceiver 22 in a wired or wireless manner. The at least one node includes, for example, a first node 10 and one or more second nodes 40ₖ, . . . 40_{N} (hereinafter collectively referred to as a second node 40). The first node 10 may be, for example, a source node of the logistics process of the object, and the second node 40 may be, for example, an intermediate node of the logistics process of the object. In addition, the processor 24 is also configured to interact with a user terminal 50 through the transceiver 22 in a wired or wireless manner. The user terminal 50 may be located, for example, at a destination node of the logistics process and used by the user to track or trace the information of the object's logistics process.

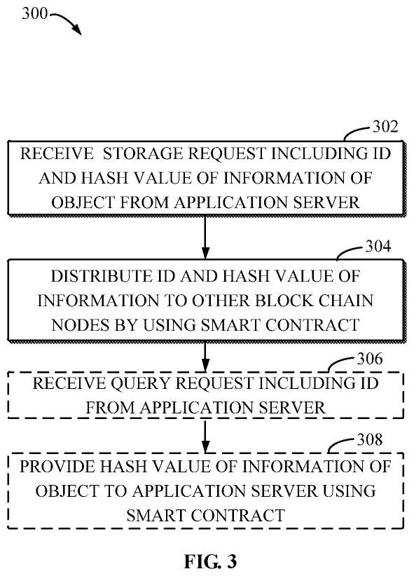

The system 100 may also include a block chain platform 30, which includes one or more block chain nodes 32. Each block chain node 32 includes a processor 322 and a memory 324. In one implementation, the memory 324 has computer program codes stored thereon that, when executed by the processor 322, perform the method 300 described below in conjunction with FIG. 3. The application server 20 may communicate with each block chain node 32 of the block chain platform 30 via a wired or wireless network 70, for example, through a block chain application interface (not shown in the figure).

In addition, the system 100 may also include a distributed database 60 coupled to the application server 20. The distributed database 60 may be part of the application server 20, or may be distributed among multiple network nodes independently of the application server 20.

FIG. 2 illustrates a flowchart of a method 200 for logistics tracking and source tracing of an object implemented in an application server according to embodiments of the present disclosure. The method 200 may be implemented in the application server 20 as shown in FIG. 1.

At block 202, the application server 20 receives a storage request from at least one node during the logistics process of the object. The storage request includes a unique identification number (ID) of the object and information of the object at the at least one node.

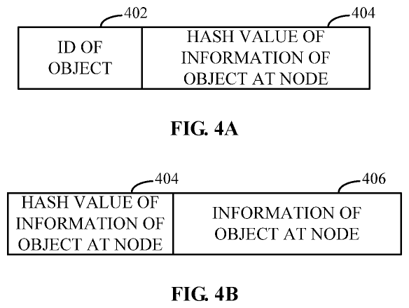

In the present disclosure, the unique identification number of the object is a public key of an IoT device that is inseparable from the object during the logistics process of the object. At the beginning of logistics transportation, the IoT device is inseparably bound with the object to be transported. This binding is usually physical so that the IoT device cannot be separated from the object without using violence during the logistics process. At the end of the logistics process, the receiver of the object may determine whether the transported object has been replaced by checking the integrity of the IoT device and the object. The IoT device is configured with a pair of public key and private key. The public key is directly used as the unique identification number of the object during the logistics process, and the private key is used for performing authentication of the identity of each node. More details regarding the IoT device will be described below with reference to the IoT device 80 in FIG. 4.

In one implementation, the at least one node includes the first node 10. The first node 10 may be, for example, a source node or a starting node of the logistics process of the object, such as the sender of the object. The information of the object at the first node 10 includes the basic information of the object, which will not change during the entire logistics process of the object. For example, the basic information of the object includes at least one of a name, a quantity, a picture, a video, a producer, a place of production, and the like of the object. This information indicates the information of the item per se sent by the sender and can be used by the user/receiver to check whether the transported item is correct after arriving at the destination, for example, to check against the order placed by the user before.

In another implementation, the at least one node includes one or more second nodes 40. The second node 40 may be, for example, an intermediate node of the logistics process of the object for recording dynamic information of the object at each second node 40. The dynamic information includes operation information of the object at each second node 40 and a time stamp corresponding to the operation information. For example, the dynamic information may include at least one of an identifier of the second node 40, an arrival time of the object at the second node 40, a departure time of the object from the second node 40, an operation performed by the second node 40 on the object, and location information of the second node 40. This information indicates the information resulting from the transfer of the item at various logistics intermediate nodes, and for different second nodes 40, the dynamic information will differ.

In an actual implementation, the application server 20 receives corresponding basic information and dynamic information from the first node 10 and the second nodes 40 in order of time over the logistics process.

It can be understood that information of the object at each node received by the application server 20 from the node can be encrypted using the private key of the IoT device.

Next, at block 204, the application server 20 performs a hash operation on the information contained in the storage request to obtain a hash value of the information. The hash operation is a kind of encryption operation, which can convert data of different length into data of equal length, thereby facilitating the management and calling of data. The hash operation described herein may be any type of hash operation known in the art or developed in the future, and the present disclosure is not intended to limit the type of hash operation.

At block 206, the application server 20 sends the hash value of the information and the information to the distributed database 60 for storage, and at block 208, the application server 20 sends the unique identification number of the object and the hash value of the information to the block chain platform 30 for storage. It will be understood that blocks 206 and 208 are not limited to the order shown in the figure and described herein, but may be performed in other orders, such as being performed simultaneously or block 206 being performed during block 208.

According to embodiments of the present disclosure, information received from the node may be stored in various ways and/or formats. FIG. 4A illustrates a schematic diagram of a storage format in the block chain platform 30 for the information of the object according to embodiments of the present disclosure. FIG. 4B illustrates a schematic diagram of a storage format in the distributed database 60 for the information of the object according to embodiments of the present disclosure.

As shown in FIG. 4A, on the block chain platform 30, a list of correspondences between the unique identification number (ID) 402 of the object and the hash value 404 of the information of the object at one node is stored. It can be understood that for the same object, a plurality of entries as shown in FIG. 4A may be stored on the block chain platform 30, where each entry contains the unique ID 402 of the object and the hash value 404 of the information of the object at one node. Alternatively, the block chain platform 30 may also store only one entry as shown in FIG. 4A, and the entry contains a list of the unique ID 402 of the object as an index and the hash values 404 of the information of the object at multiple nodes. The hash values 404 of the information of the object at multiple nodes may be arranged, for example, in the order of the hash value 404 of the information at the first node 10 first, and then the hash values 404 of the information at multiple second nodes 40. The hash values 404 of the information at the multiple second nodes 40 may be arranged in the order of the time stamps contained in the information. The present disclosure is not limited thereto, and each hash value 404 may also be arranged in other orders without affecting the scope of the present disclosure.

As shown in FIG. 4B, in the distributed database 60, a list of correspondences between information 406 of the object at one node and the hash value 404 of the information 406 of the object at the node is stored. For the same object, a plurality of entries as shown in FIG. 4B may be stored in the distributed database 60, where each entry contains the hash value 404 of the information of the object at one node as an index and the information 406 per se. Alternatively, the distributed database 60 may also store only one entry as shown in FIG. 4B, and the entry contains a list of the hash values 404 of the information of the object at multiple nodes as indexes and the information 406 of the object at multiple nodes. Similarly, the information 406 of the object at the multiple nodes may be arranged in the order of the information 406 at the first node 10 first, and then the information 406 at the multiple second nodes 40. The information 406 at the multiple second nodes 40 may be arranged in the order of the time stamps contained in the information. The present disclosure is not limited thereto, and respective pieces of information 406 may also be arranged in other orders without affecting the scope of the present disclosure.

Since the information received by the application server 20 may have a relatively large amount of data, by merely storing the hash values of the information on the block chain platform and storing the information itself in a distributed database, it is possible to reduce storage costs while achieving secure storage.

The above method steps 202 to 208 describe the process of the application server 20 receiving information about the object from various logistics nodes and storing it in a block chain during the logistics process of the object. The information indicates the source information (basic information) and logistics tracking information of the object. By storing this information on the block chain, it is guaranteed that this information cannot be tampered with. And the storage of this information in the logistics process does not require manual intervention, thus avoiding the insecurity due to manual operations.

In some embodiments, the method 200 may also optionally include the process of the user acquiring such information through the application server 20 when the object arrives at the destination.

For example, at block 210, the application server 20 receives a query request from the user terminal 50 which includes the unique identification number of the object. The user terminal 50 may be, for example, a user terminal for the receiver of the object. When the object reaches its destination, its receiver can use the user terminal 50 to read from the IoT device bound with the object the public key of the IoT device, i.e. the unique identification number of the object, and to send a query request to the application server 20 for the basic information of the object and/or the dynamic information at respective intermediate nodes 40 during the logistics process.

In response to the query request from the user terminal 50, at block 212, the application server 20 obtains a hash value of the information of the object at at least one node in the logistics process from the block chain platform 30 based on the unique identification number of the object. For example, the application server 20 may use the unique identification number 402 of the object as an index to directly obtain the hash value 404 of the information of the object at the at least one node from the list of correspondences stored in the block chain platform 30 as shown in FIG. 4A. Alternatively, the application server 20 may send the query request to the block chain node 32 of the block chain platform 30. The block chain node 32 uses, for example, a smart contract to obtain the hash value of the information of the object at the at least one node during the logistics process from the list of correspondences stored in the block chain platform 30 as shown in FIG. 4A with the unique identification number 402 of the object as an index.

As mentioned above, the query request may be for basic information or dynamic information only, or for both. If the query request is only for the basic information at the first node 10 or the dynamic information at one or more second nodes 40, the query request may also include the identifier of the first node 10 or those of the one or more second nodes 40.

At block 214, the application server 20 extracts the information 406 of the object from the distributed database 60 based on the hash value 404 of the information of the object at the at least one node obtained from the block chain platform 30. For example, the application server 20 may obtain the information 406 of the object at the at least one node from the list of correspondences stored in the distributed database 60 as shown in FIG. 4B with the hash value 404 as an index.

Next at block 216, the application server 20 transmits the extracted information 406 of the object to the user terminal 50.

In this way, the receiver of the object can obtain information of the object at at least one node during the logistics process through the application server 20, including the basic information of the object and the dynamic information of the object at respective intermediate nodes.

FIG. 3 illustrates a flow chart of a method 300 for logistics tracking and source tracing of the object implemented in a block chain node according to embodiments of the present disclosure. The method 300 may be performed by, for example, a block chain node 32 in the block chain platform 30 as shown in FIG. 1.

At block 302, a block chain node 32 in the block chain platform 30 receives a storage request from the application server 20. The storage request includes the unique identification number of the object and the hash value of the information of the object at at least one node during the logistics process.

At block 304, the block chain node 32 distributes the unique identification number of the object and the hash value of the information to other block chain nodes 32 in the block chain platform 30 by using a smart contract. Here, each block chain node 32 is a host of the smart contract, also referred to as a smart contract entity in this disclosure. The smart contract may be developed by a developer of the system 100 or other providers and may be distributed to all the block chain nodes 32 in the block chain platform 30 or part of them. A safe and credible third party security guarantee is provided by implementing the information chaining with the smart contract on the block chain platform 30.

In one implementation, the at least one node includes the first node 10 as described above. In this case, the smart contract may be a first smart contract that is dedicated to sending the basic information of the object to other block chain nodes 32 in the block chain platform 30.

In another implementation, the at least one node includes one or more second nodes 40 as described above. In this case, the smart contract may be a second smart contract, which is dedicated to sending the dynamic information of the object from the second nodes 40 to other block chain nodes 32 in the block chain platform 30.

In yet another implementation, it is also possible to use just one smart contract (not shown in the figure) to implement the functions of the first smart contract and the second smart contract described above.

For example, at block 306, the block chain node 32 receives the query request from the application server 20 which includes the unique identification number of the object.

At block 308, the block chain node 32 utilizes the smart contract to provide the application server 20 with a hash value of the information of the object at the at least one node in response to the query request. For example, the block chain node 32 may use the smart contract to obtain the hash value of the information of the object at the at least one node during the logistics process from the list of correspondences stored in the block chain platform 30 as shown in FIG. 4A with the unique identification number 402 of the object as an index.

In this way, upon receipt of a query from the user (e.g., the receiver of the transported object), for example, the application server 20 can use the unique identification number of the object to access the block chain platform 30 and to obtain the hash value of the information of the object during the logistics process so as to further obtain the information per se of the object during the logistics process.

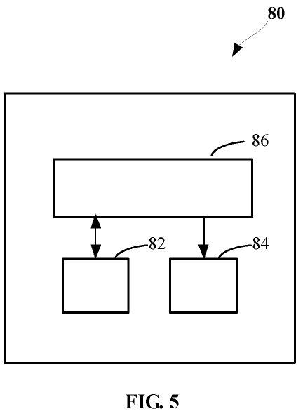

FIG. 5 illustrates a structure block diagram of an IoT device 80 for logistics tracking and source tracing of an object according to embodiments of the present disclosure. As shown in FIG. 5, the IoT device 80 includes a readable memory 82 and an unreadable memory 84. The IoT device 80 may be configured with a pair of public key and private key. The public key is stored in the readable memory 82 and the private key is stored in the unreadable memory 84. In this way, it is ensured that only the IoT device 80 itself can use the private key, and other entities (such as the application server 20, the first node 10, the second node 40, the user terminal 50 and the like shown in FIG. 1) can obtain the public key of the IoT device 80 from the readable memory 82 so that the pair of public key and private key can be utilized at respective nodes or destination of the logistics process to authenticate the identities of the first node 10, the second node 40, and/or the user terminal 50.

The pair of public key and private key in the IoT device 80 may be generated in various ways. In one implementation, the IoT device 80 also includes a processor 86 as shown in FIG. 5. In this case, the processor 86 may generate the pair of public key and private key based on a known key generation algorithm and store the generated public key in the readable memory 82 and store the generated private key in the unreadable memory 84.

In another implementation, the pair of public key and private key may be generated by the application server 20 or other entity of the provider of the system 100, and sent to the IoT device 80 to be stored in the readable memory 82 and the unreadable memory 84, respectively. In this case, the generator of the public key and the private key, such as the application server 20, should discard the private key and only hold the public key after sending the generated public key and private key to the IoT device 80. In this way, it is also ensured that the private key may only be used by the IoT device 80 itself.

The IoT device 80 may be provided by a provider of the system 100, for example, and is inseparably bound to the object before transporting the object (e.g., the item). Unless violently destroyed, the IoT device 80 and the object to be transported cannot be separated. Therefore, the public key of the IoT device 80 may be used as the unique identification number of the object during the logistics process.

In addition, at the first node 10 and/or each second node 40, a device such as a scanner may be used to interact with the IoT device 80 to authenticate the identity of each node.

Specifically, at each node, the application server 20 may acquire a random number and send the random number to the IoT device 80, for example via an application at the node or otherwise. Then, the application server 20 may receive the random number signed by the private key of the IoT device 80 and the public key of the IoT device 80 from the IoT device 80. The application server 20 decrypts the signed random number by using the public key of the IoT device 80, and compares the decrypted result with the random number itself. If the comparison result indicates that they are the same, the application server 20 can receive information from the node. It can be understood that the process of authenticating the node may be performed before the block 202 of the method 200 shown in FIG. 2.

Similarly, at the receiver of the object, a device such as the user terminal 50 may be used to interact with the IoT device 80 to authenticate the identity of the user terminal 50. It can be understood that the authentication process of the user terminal 50 may be performed before the block 210 of the method 200 shown in FIG. 2.

In one or more exemplary designs, the functions described by the embodiments of the present disclosure may be implemented in hardware, software, firmware, or any combination thereof. If implemented in software, the functions may be stored on or transmitted over as one or more instructions or codes on a computer-readable medium.

The various units of the device described herein may be implemented with discrete hardware components or integrally in a single hardware component such as a processor. For example, the various illustrative logical blocks, modules, and circuits described in connection with the present disclosure may be implemented within or performed by a general purpose processor, a digital signal processor (DSP), an application specific integrated circuit (ASIC), a field programmable gate array (FPGA) or other programmable logic device, a discrete gate or transistor logic, discrete hardware components, or any combination thereof designed to perform the functions described herein.

Those skilled in the art would further appreciate that any of the various illustrative logical blocks, modules, processors, means, circuits, and algorithm steps described in connection with the embodiments of the present disclosure herein may be implemented as electronic hardware, computer software, or combination thereof.

The previous description of the embodiments of the present disclosure is provided to enable any person skilled in the art to make or use the present disclosure. Various modifications to the embodiments of the present disclosure will be readily apparent to those skilled in the art, and the generic principles defined herein may be applied to other aspects without departing from the spirit and scope of the present disclosure. Thus, the present disclosure is not intended to be limited to the examples and designs shown herein but is to be accorded the widest scope consistent with the principles and novel features disclosed herein.

1. An application server for logistics tracking and source tracing of an object, comprising:
a memory and a processor, the memory being stored with machine executable instructions that, when executed by the processor, cause the application server to perform operations including:
receiving a storage request from at least one node during a logistics process of the object, the storage request including a unique identification number of the object and information of the object at the at least one node, wherein the unique identification number of the object is a public key of an Internet of Things (IoT) device that is inseparable from the object during the logistics process;
performing a hash operation on the information to obtain a hash value of the information;
sending the hash value of the information and the information to a distributed database for storage; and
sending the unique identification number of the object and the hash value of the information to a block chain platform for storage.

2. The application server of claim 1, wherein the operations further include:
receiving a query request from a user terminal, the query request including the unique identification number of the object;
obtaining, from the block chain platform based on the unique identification number of the object, the hash value of the information of the object at the at least one node during the logistics process of the object, in response to the query request;
extracting, from the distributed database based on the hash value of the information of the object at the at least one node during the logistics process of the object, the information of the object at the at least one node during the logistics process of the object; and
sending the information to the user terminal.

3. The application server according to claim 1, wherein the at least one node includes a first node, and the information of the object at the at least one node includes basic information of the object that will not change during entire logistics process of the object.

4. The application server of claim 3, wherein the basic information of the object includes at least one of a name, a quantity, a picture, a video, a producer, and a place of production of the object.

5. The application server of claim 1, wherein the at least one node includes one or more second nodes, and the information of the object at the at least one node includes dynamic information of the object at each of the one or more second nodes, the dynamic information including operation information of the object at the second node and a time stamp of the operation information.

6. The application server of claim 5, wherein the dynamic information of the object includes at least one of an identifier of the second node, an arrival time of the object at the second node, a departure time of the object from the second node, an operation performed by the second node on the object, and location information of the second node.

7. A method for logistics tracking and source tracing of an object, comprising:
receiving a storage request from at least one node during a logistics process of the object, the storage request including a unique identification number of the object and information of the object at the at least one node, wherein the unique identification number of the object is a public key of an Internet of Things (IoT) device that is inseparable from the object during the logistics process;
performing a hash operation on the information to obtain a hash value of the information;
sending the hash value of the information and the information to a distributed database for storage; and
sending the unique identification number of the object and the hash value of the information to a block chain platform for storage.

8. The method of claim 7, further comprising:
receiving a query request from a user terminal, the query request including the unique identification number of the object;
obtaining, from the block chain platform based on the unique identification number of the object, the hash value of the information of the object at the at least one node during the logistics process of the object, in response to the query request;
extracting, from the distributed database based on the hash value of the information of the object at the at least one node during the logistics process of the object, the information of the object at the at least one node during the logistics process of the object; and
sending the information to the user terminal.

9. The method according to claim 7, wherein the at least one node includes a first node, and the information of the object at the at least one node includes basic information of the object that will not change during entire logistics process of the object.

10. The method of claim 9, wherein the basic information of the object includes at least one of a name, a quantity, a picture, a video, a producer, and a place of production of the object.

11. The method of claim 7, wherein the at least one node includes one or more second nodes, and the information of the object at the at least one node includes dynamic information of the object at each of the one or more second nodes, the dynamic information including operation information of the object at the second node and a time stamp of the operation information.

12. The method of claim 11, wherein the dynamic information of the object includes at least one of an identifier of the second node, an arrival time of the object at the second node, a departure time of the object from the second node, an operation performed by the second node on the object, and location information of the second node.

13. A nonvolatile computer readable storage medium for logistics tracking and source tracing of an object comprising machine executable instructions that, when executed by a machine, are adapted to cause a machine to implement the method of claim 7.

14. A block chain node for logistics tracking and source tracing of an object comprising:
a memory and a processor, the memory being stored with machine executable instructions that, when executed by the processor, cause the block chain node to perform operations including:
receiving a storage request from an application server, the storage request including a unique identification number of the object and a hash value of information of the object at at least one node during a logistics process of the object, wherein the unique identification number of the object is a public key of an Internet of Things (IoT) device that is inseparable from the object during the logistics process; and
distributing the unique identification number of the object and the hash value of the information to one or more other block chain nodes by using a smart contract.

15. The block chain node of claim 14, wherein the operations further include:
receiving a query request from the application server, the query request including the unique identification number of the object; and
providing the application server with the hash value of the information of the object at the at least one node during the logistics process by using the smart contract, in response to the query request.

16. The block chain node of claim 14, wherein the at least one node includes a first node, and the information of the object at the at least one node includes basic information of the object that will not change during entire logistics process of the object, and wherein the smart contract includes a first smart contract.

17. The block chain node of claim 16, wherein the basic information of the object includes at least one of a name, a quantity, a picture, a video, a producer, and a place of production of the object.

18. The block chain node of claim 14, wherein the at least one node includes one or more second nodes, and the information of the object at the at least one node includes dynamic information of the object at each of the one or more second nodes, the dynamic information including operation information of the object at the second node and a time stamp of the operation information, and wherein the smart contract includes a second smart contract.

19. The block chain node of claim 18, wherein the dynamic information of the object includes at least one of an identifier of the second node, an arrival time of the object at the second node, a departure time of the object from the second node, an operation performed by the second node on the object, and location information of the second node.

20. A method for logistics tracking and source tracing of an object, comprising:
receiving a storage request from an application server, the storage request including a unique identification number of the object and a hash value of information of the object at at least one node during a logistics process of the object, wherein the unique identification number of the object is a public key of an Internet of Things (IoT) device that is inseparable from the object during the logistics process; and
distributing the unique identification number of the object and the hash value of the information to one or more other block chain nodes by using a smart contract.

21. The method of claim 20, further comprising:
receiving a query request from the application server, the query request including the unique identification number of the object; and
providing the application server with the hash value of the information of the object at the at least one node during the logistics process by using the smart contract, in response to the query request.

22. The method of claim 20, wherein the at least one node includes a first node, and the information of the object at the at least one node includes basic information of the object that will not change during entire logistics process of the object, and wherein the smart contract includes a first smart contract.

23. The method of claim 22, wherein the basic information of the object includes at least one of a name, a quantity, a picture, a video, a producer, and a place of production of the object.

24. The method of claim 20, wherein the at least one node includes one or more second nodes, and the information of the object at the at least one node includes dynamic information of the object at each of the one or more second nodes, the dynamic information including operation information of the object at the second node and a time stamp of the operation information, and wherein the smart contract includes a second smart contract.

25. The method of claim 24, wherein the dynamic information of the object includes at least one of an identifier of the second node, an arrival time of the object at the second node, a departure time of the object from the second node, an operation performed by the second node on the object, and location information of the second node.

26. A nonvolatile computer readable storage medium for logistics tracking and source tracing of an object comprising machine executable instructions that, when executed by a machine, are adapted to cause a machine to implement the method of claim 20.
